(19) United States
(12) Patent Application Publication
(10) Pub. No.: US 2006/0109272 A1
(43) Pub. Date: May 25, 2006

(54) ELECTRONIC PRESENTATION SYSTEM

(75) Inventor: Toru Murata, Tokyo (JP)

Correspondence Address: SUGHRUE MION, PLLC, 2100 PENNSYLVANIA AVENUE, N.W., SUITE 800, WASHINGTON, DC, 20037, US

(73) Assignee: NEC CORPORATION

(21) Appl. No.: 11/275,496

(22) Filed: Jan. 10, 2006

Related U.S. Application Data
(63) Continuation of application No. 09/933,017, filed on Aug. 21, 2001.

(30) Foreign Application Priority Data
Aug. 22, 2000 (JP) 250897/2000

(51) Int. Cl. G06T 11/20

(52) U.S. Cl. 345/440

(57) ABSTRACT

An electronic presentation system of the present invention comprises: communication means; a first image and voice display means connected to the communication means in which display control and communication control through the communication means are controlled by remote control means; and a personal computer provided with a second image and voice display means connected to the communication means and different from the first image and voice display means placed in a position different from the position placing the first image and voice display means, and input means; wherein the remote control means selects the display contents displayed on the second image and voice display means to display the selected display contents on the first image and voice display means at the same time.

This application is a continuation of application Ser. No. 09/933,017, filed Aug. 21, 2001, the entire disclosure of which is incorporated by reference herein.

### FIELD OF THE INVENTION

The present invention relates to an electronic presentation system, more specifically, to an electronic presentation system for performing presentation using a PC and electronic image projection means connected by communication means.

### DESCRIPTION OF THE PRIOR ART

When performing electronic presentation, there is generally employed a method in which a projector and a PC (Personal Computer) previously installing presentation software are placed in a presentation hall such as a meeting room, data of removable media such as a floppy disk is brought in, and the data file is opened by the presentation software installed into the PC, whereby the projector also connected to the PC projects and displays the data file. The method, however, has the following problems.

First, when the types and versions are not compatible between the presentation software installed into the PC placed in the hall and the presentation software incorporated in a PC for use in creation of the presentation screen, the data file cannot be opened and the screen cannot be presented, either.

Second, when the types and formats of the removable media for brining the data in are not compatible between the PC placed in the hall and the working PC, the screen cannot be presented.

Third, to bring the removable media in, it takes the trouble to move the data from the hard disk incorporated in the PC for use in working to the removable media. Further, damage or deterioration during carrying of the removable media must be careful as the fourth problem.

In particular, the influences of the above-mentioned first and second disadvantages are significant. For this reason, with increase in the function of a portable personal computer, there has been often employed a method in which a portable personal computer installing both data and presentation software is brought in, which is then connected to a projector placed in a hall such as a meeting room to display the presentation screen. However, also in this case, there are problems: 1) it takes the trouble to carry a PC itself and damage such as dropping during carrying it must be careful; 2) there must be prepared a projector to be connected, and a conversion interface or cable corresponding to the PC type; and 3) when the PC to be moved is a shared PC, that is, is not the same as the working PC, it takes the trouble to move data from the working PC.

Japanese Published Unexamined Patent Application No. Hei 09-325413 proposes a system including an output device replaying and outputting a general-purpose image file (BMP (Bit Map) or JPEG) to solve or reduce the forgoing problems 1) and 2). As an embodiment thereof, there is employed a method in which a projector and an output device are placed in a hall such as a meeting room to bring data of removable media (memory card) in. At present, a projector incorporating the output device is commercialized. However, also in this case, it takes the trouble to convert the data to a general-purpose image file which is then moved to the removable media (memory card). TAT (Turn Around Time) for re-editing is thus long.

To reduce the working TAT, the desire from electronic presentation users to directly use the contents of their own PC with a network has been significant in recent years. To meet this, there has been an approach in which a PC placed in a hall is connected to a working PC by LAN (Local Area Network) to transfer a file. However, in this case, since the file to be transferred is a storing file of the presentation software, there still remains the problem that presentation cannot be performed unless the types and versions are compatible between the presentation software installed in the PC placed in the hall and the presentation software incorporated in the working PC.

The present invention has been made in view of the foregoing problems of the prior art and accordingly, an object of the present invention is to provide a presentation system in which a PC of an office is operated from a meeting room, and then, a projection processing part (projector) of the meeting room enlargeably project an image displayed on the PC by the operation to perform presentation, which can solve the problems of the compatibility in presentation software or data files as well as the working TAT and avoid damage of a memory medium when carried, and which further can enrich a user interface by operating only a remote controller transmitter of the projector serving as a pointer.

### BRIEF SUMMARY OF THE INVENTION

### Objects of the Invention

An object of the present invention is to provide a presentation system in which a PC of an office is operated from a meeting room, and then, a projection processing part (projector) of the meeting room enlargeably project an image displayed on the PC by the operation to perform presentation, which can solve the problems of the compatibility in presentation software or data files as well as the working TAT and avoid damage of a memory medium when carried, and which further can enrich a user interface by operating only a remote controller transmitter of the projector serving as a pointer.

### Summary of the Invention

An electronic presentation system of the present invention comprising: communication means; a first image and voice display means connected to the communication means in which display control and communication control through the communication means are controlled by remote control means; and a personal computer provided with a second image and voice display means connected to the communication means and different from the first image and voice display means placed in a position different from the position placing the first image and voice display means, and input means; wherein the remote control means selects the display contents displayed on the second image and voice display means to display the selected display contents on the first image and voice display means at the same time.

### BRIEF DESCRIPTION OF THE DRAWINGS

The above-mentioned and other objects, features and advantages of this invention will become more apparent by reference to the following detailed description of the invention taken in conjunction with the accompanying drawings, wherein:

FIG. 1 is a diagram showing the construction of an embodiment of the present invention;

FIG. 2 is a diagram showing the key positions of a remote control transmitter included in the construction of the embodiment of the present invention; and

FIG. 3 is a diagram of assistance in explaining the correspondence of the keys of the remote control transmitter to the keys of the keyboard in the embodiment of the present invention.

### DETAILED DESCRIPTION OF THE INVENTION

The embodiment of the present invention will be described with reference to the drawings.

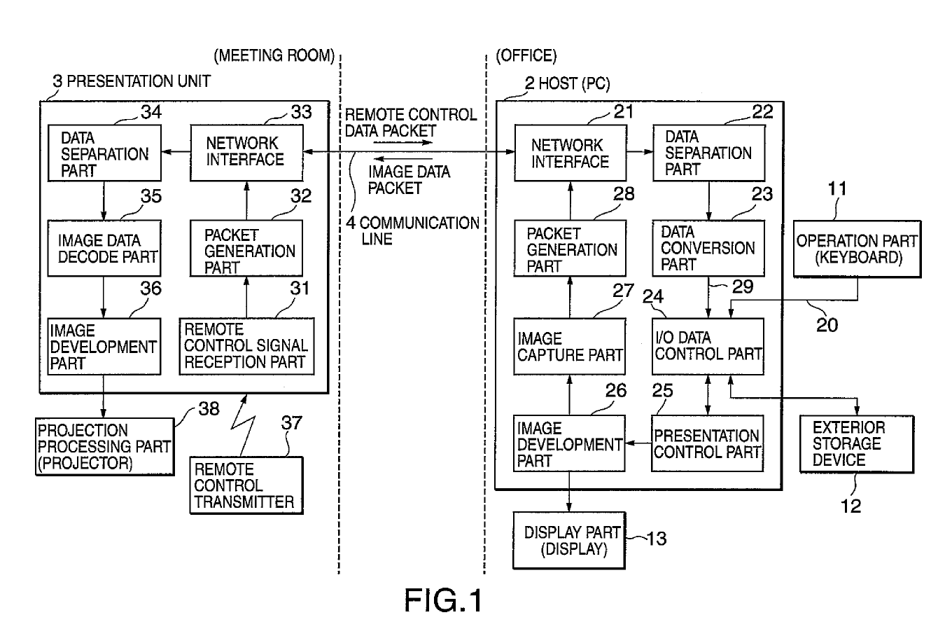

FIG. 1 is a diagram showing the construction of a presentation system of the present invention. A presentation system 1 has a host (PC) 2 placed in an office side and connected to an operation part (keyboard) 11 and a display part (display) 13, and a presentation unit 3 placed in a meeting room side and connected to a projection processing part 38 as a projector. The host (PC) 2 is connected to the presentation unit 3 by a communication line 4 such as LAN. A remote control transmitter 37 can remotely operate the presentation unit 3 and the projection processing part 38 as a projector.

The remote control transmitter 37 generates an infrared signal corresponding to the operation of the user. A remote control signal reception part 31 provided in the presentation unit 3 converts the infrared signal outputted from the remote control transmitter 37 to remote control data. A packet generation part 32 adds overhead such as a destination address or a source address to the remote control data which is then in a packet form, so that the data can be adapted to signal transmission of the communication line 4 such as LAN. A network interface 33 sends out the remote control data packet to the communication line 4. In this manner, the remote control data from the remote control transmitter 37 received by the presentation unit 3 is sent to the host 2.

A network interface 21 of the host (PC) 2 side receives the remote control data packet sent through the communication line 4 to pass the packet to a data separation part 22. The data separation part 22 removes the overhead such as a destination address or a source address from the frame of the remote control data packet to fetch the remote control data. A data conversion part 23 converts the remote control data to input data equivalent to the input signal corresponding to the type of the PC input device such as a keyboard to input the input data to an I/O data control part 24. The I/O data control part 24 reads presenting data from an exterior storage device 12 corresponding to the data from the operation part (keyboard) 11 or the data conversion part 23 to send the presenting data to a presentation control part 25. The presentation control part 25 decodes the presenting data to output the decoded data to an image development part 26. The image development part 26 converts the image data to an image signal to output the signal to the display part (display) 13. The display part (display) 13 displays the image on a CRT or LCD. An image capture part 27 captures the image displayed on the display part (display) 13 from the image development part 26, and converts the image to image data which is then sent to a packet generation part 28. The packet generation part 28 adds overhead to the image data which is then in a packet form, so that the image data can be adapted to transmission of the communication line 4, and then, sends out the image data packet through the communication line 4 to the presentation unit 3.

The presentation unit 3 passes the image data packet from the communication line 4 received by the network interface 33 to a data separation part 34. The data separation part 34 removes the overhead from the frame of the image data packet to fetch the image data. An image data decode part 35 decodes the image data to develop the decoded data to the image development part 36. The image development part 36 converts the developed image data to an image signal such as RGB or a composite signal to output the image signal to the projection processing part (projector) 38. The projection processing part (projector) 38 enlargeably projects the image onto a screen.

The communication line 4 is assumed to be Ethernet here and transmits the remote control data and the image data which are in a packet form.

The I/O data control part 24 is assumed to be basic software (OS: Operating System) of the PC. The presentation control part 25 is assumed to be application software, more specifically, presentation software.

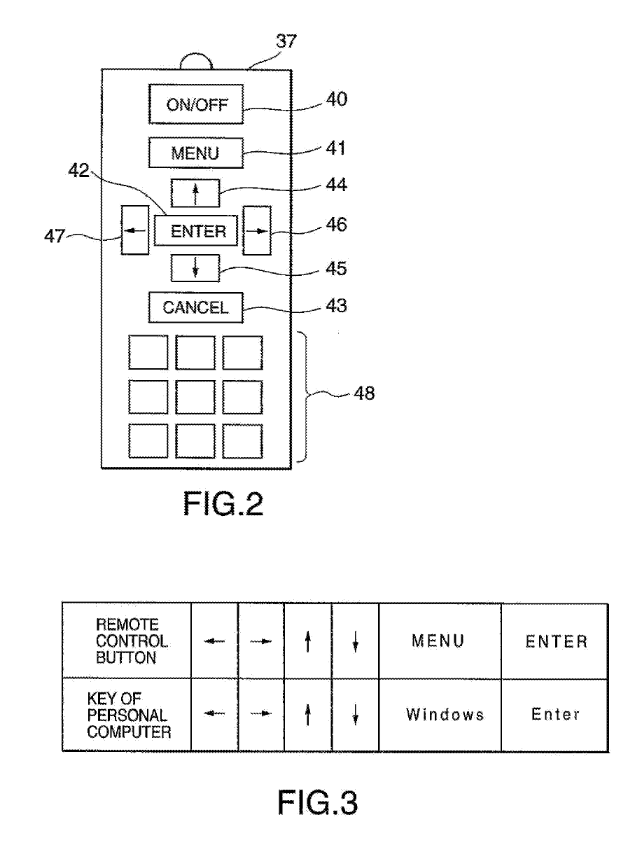

With reference to the presentation system 1 of FIG. 1 and the remote control transmitter 37 shown in FIG. 2, a procedure for operating the PC of the office from the meeting room for performing presentation will be described hereinbelow. In FIG. 2, there is assumed the placement of buttons provided in the remote control transmitter 37 generally used in the projector 38. The remote control transmitter 37 has a power switch 40, a menu button 41 invoking the menu, cursor move buttons 44 to 47 for moving the cursor flashing on the menu in the upward and downward direction or in the right and left direction, a decide button for inputting decision, a cancel button 43, and a projection screen adjust button 48 for adjusting, such as focusing or enlarging/reducing, a projection screen of the projector.

The presenter first uses the mouse (not shown) or the operation part (keyboard) 11 of his/her own host (PC) 2 in the office before going to the meeting room to operate OS (the I/O data control part 24) of the PC, thereby setting to invalidate an input 20 from the keyboard 11 or the mouse pointer (not shown) to the PC and validate only an input 29 from the communication line 4. Releasing the setting can be returned to the initial state by depressing any key on the keyboard.

The presenter who has moved to the meeting room depresses the power switch 40 of the remote control transmitter 37 to start the presentation unit 3 and the projector 38. The menu button is pressed to display the menu screen on the projection screen of the projector. The displayed menu screen displays “Input AV device (input composite signal)”, “Input PC (input RGB signal)”, and “Connect LAN”. On the menu screen, the cursor move buttons 44 to 47 are operated to move the cursor to the position of “Connect LAN”, thereby pressing the decide button 42 (ENTER) for inputting the decision. The projection screen is switched to display the list of the destination addresses connected by LAN. The presenter operates the cursor move buttons 44 to 47 to move the cursor to the address display of his/her own PC to press the decide button 42 (ENTER) for inputting the decision. The projection screen of the projector is changed from the menu screen to display the screen remote from the display 13 of his/her own host (PC) 2 placed in the office transmitted through the communication line 4.

The operation of the data conversion part 23 of the host (PC) 2 will be described here.

The data conversion part 23 converts the remote control data to input data equivalent to the input signal corresponding to the type of the PC input device such as a keyboard or a mouse pointer. The conversion is done, for example, based on the correspondence table as shown in FIG. 3. The data conversion part 23 correspondingly converts the codes “←”, “→”, “↑” and “↓” of the remote control outputted from the data separation part 22 of the host (PC) 2 to the codes “←”, “→”, “↑” and “↓” of the operation part (keyboard) 11, and correspondingly converts “MENU” and “ENTER” of the remote control to the codes “Windows” and “Enter” of the keyboard of the personal computer.

The presenter views the screen of the display 13 of the host (PC) 2 displayed on the projection screen of the projector to press the menu button 41 of the remote control transmitter. The data conversion part converts the code from the remote control transmitter transmitted to the host (PC) 2 to the code when the “Windows” key of the operation part (keyboard) of the PC is depressed, whereby the converted code is inputted to the I/O data control part 24. On the left end of the projection screen, the menu indicating PC working such as “Programs (P)” or “Recently used files (D)” appears.

The presenter presses “↑” of the upward move button 41 of the remote control transmitter to move the indicating cursor on the menu onto “Recently used files (D)”, thereby pressing “ENTER” of the decide button 42 of the remote control transmitter. On the side of the above-mentioned menu on the display screen, the list of the recently used files including files which have been created for presentation appears.

The presenter presses “↑” of the upward move button 41 of the remote control transmitter again to move the cursor to the position of the file name for use in the presentation, thereby pressing “ENTER” of the decide button 42 of the remote control transmitter. The presentation software as the application software then starts up on the host (PC) to open a desired file which is then projected on the display screen of the projector. The forward and rearward movement of the displayed page is done by operating the buttons “↑” and “↓” of the remote control transmitter.

When the presentation is finished, the presenter presses the menu button 41 of “MENU” of the remote control transmitter again. On the left end of the projection screen, the menu screen indicating PC working such as “Programs (P)” or “Recently used files (D)” is returned. Movement to another file or termination of the PC can be done.

The presenter can press the power switch 40 of the remote control transmitter to turn off the projector 38 and the presentation unit 34.

The presenter who has returned to the office presses the “Enter” key of his/her own PC to return it to the initial state when the PC is operating, in order to switch the input mode to the PC from the communication line to the input operation part (keyboard) of the PC itself

In this embodiment, the operation part is assumed to be the keyboard to set the correspondence table of conversion of the data conversion part 23. In place of the keyboard, the operation part may be a form for changing the input signal to a signal equivalent to pointing devices such as a mouse, track ball, and tablet so as to be replaced by an operation from the devices. For example, in the case of the mouse, “→”, “←”, “↑”, “↓”, “ENTER” and “MENU” of the remote control transmitter respectively corresponds to the right movement, left movement, upward movement, downward movement, left click, and right click of the mouse. The remote control transmitter can move and click the mouse pointer on the projection screen.

In addition, in the above-mentioned embodiment, the communication line is assumed to be Ethernet. The above-mentioned embodiment is not limited to Ethernet. When the presentation unit 3 can be correspondingly communicated with the host (PC) 2, the presentation line 3 and the host (PC) 2 may use a dedicated line or may be directly connected to each other. Not only wired communication but also a wireless public phone line or wireless communication means such as wireless LAN may be used.

The projector can generally replay voice. In the above-mentioned embodiment, when the PC display includes an image as well as voice, the projector can replay the voice at the same time.

Further, in the above-mentioned embodiment, the presentation unit 3 has another construction of the projection processing part (projector) 38. The presentation unit 3 may be incorporated in the projection processing part (projector) 38, and the remote control signal reception part 31 may be shared so as to be used for both operation of the presentation unit 3 and the projection processing part (projector) 38.

As described above, the presentation system of the present invention has the following effects.

A first effect can execute presentation without bringing a PC into a meeting roorm The reason is that the PC of an office storing data from a meeting room can be operated to project the image by a projector of the meeting room.

A second effect can correspond to presentation software without limiting the type and version thereof to make the most of the function. The reason is that a remote control signal is converted to a keyboard signal which is then supplied to OS, and the display screen of the PC directly captured is converted to image data which is then projected by the projector. That is, unless the interface is changed, the data is not affected by other parts, particularly, by the change of the data form stored in a storage device and of the function of the presentation software.

A third effect can greatly improve working efficiency and effects in the case that time sufficient to create data cannot be obtained or that modifications are made while performing some rehearsals for the real thing. The reason is that data stored in the PC of the office for use in the creation can be directly used as presenting data without any modification at all, so that TAT from creation of presenting data to completion of presentation preparation can be reduced.

Although the invention has been described with reference to specific embodiments, this description is not meant to be construed in a limiting sense. Various modifications of the disclosed embodiments will become apparent to persons skilled in the art upon reference to the description of the invention. It is therefore contemplated that the appended claims will cover any modifications or embodiments as fall within the true scope of the invention.

1-12. (canceled)

13. A projector, comprising:
a projection processing part to project an image;
an input device to input a control signal; and
an Ethernet interface device,
wherein said Ethernet interface device transmits control data based on said control signal and receives image data, and
wherein said projection processing part projects said image based on said image data.

14. The projector according to claim 13,
wherein said input device is a remote control signal receiver.

15. The projector according to claim 14, further comprising:
a remote control transmitter,
wherein said remote control transmitter transmits said remote control signal to said remote control signal receiver.

16. The projector according to claim 13,
wherein said control signal comprises a direction.

17. The projector according to claim 16,
wherein said direction is one of up, down, left and right.

18. The projector according to claim 13,
wherein said control data comprises a direction.

19. The projector according to claim 18,
wherein said direction is one of up, down, left, and right.

20. A projector, comprising:
projection processing means for projecting an image;
input means for inputting a control signal; and
communications means for communicating via Ethernet,
wherein said communications means transmits control data based on said control signal and receives image data, and
wherein said projection processing means projects said image based on said image data.

21. A projector, comprising:
a projection processing part to project an image;
an input device to input a control signal; and
a device port that is adaptable to accepting an Ethernet interface device,
wherein control data based on said control signal are transmitted through said device port and image data are received through said device port, and
wherein said projection processing part projects said image based on said image data.

22. The projector according to claim 21,
wherein said input device is a remote control signal receiver.

23. The projector according to claim 22, further comprising:
a remote control transmitter,
wherein said remote control transmitter transmits said remote control signal to said remote control signal receiver.

24. The projector according to claim 21,
wherein said control signal comprises a direction.

25. The projector according to claim 24,
wherein said direction is one of up, down, left, and right.

26. The projector according to claim 21,
wherein said control data comprises a direction.

27. The projector according to claim 26,
wherein said direction is one of up, down, left, and right.

28. A projector, comprising:
projection processing means for projecting an image;
input means to input a control signal; and
device accepting means for accepting an Ethernet interface device,
wherein control data based on said control signal are transmitted through said device accepting means and image data are received through said device accepting means, and
wherein said projection processing means projects said image based on said image data.

29. A computer, comprising:
an image development part to develop an image to be displayed for the computer;
an input device to input a first control signal;
an Ethernet interface device; and
a data conversion part to convert control data to a second control signal equivalent to said first control signal;
wherein said Ethernet interface device receives said control data and transmits image data that correspond to said image, and
wherein said image development part is controlled based on said first control signal and on said second control signal alternatively.

30. The computer according to claim 29,
wherein said input device comprises a mouse.

31. The computer according to claim 30,
wherein said input device comprises a keyboard.

32. A computer, comprising:
image development means for developing an image to be displayed for the computer;
input means for inputting a first control signal;
communications means for communicating via Ethernet; and
data conversion means for converting control data to a second control signal equivalent to said first control signal,
wherein said communications means receives said control data and transmits image data that correspond to said image, and
wherein said image development means is controlled based on said first control signal and on said second control signal alternatively.

33. A computer, comprising:
an image development part to develop an image to be displayed for the computer;
a device port that is adaptable to accepting an input device to input a first control signal;
an Ethernet interface device; and
a data conversion part to convert control data to a second control signal equivalent to said first control signal;
wherein said Ethernet interface device receives said control data and transmits image data that correspond to said image,
wherein said image development part is controlled based on said first control signal and on said second control signal alternatively.

34. The computer according to claim 33,
wherein said input device comprises a mouse.

35. The computer according to claim 34,
wherein said input device comprises a keyboard.

36. A computer, comprising:
image development means for developing an image to be displayed for the computer;
device accepting means for accepting an input device to input a first control signal;
communications means for communicating via Ethernet, and
data conversion means for converting control data to a second control signal equivalent to said first control signal,
wherein said communications means receives control data and transmits image data that correspond to said image,
wherein said image development means is controlled based on said first control signal and on said second control signal alternatively.

37. A presentation system, comprising:
a computer, said computer including:
an image development part to develop an image to be displayed for the computer;
a device port that is adaptable to accepting an input device to input a first control signal;
a first Ethernet interface device; and
a data conversion part to convert control data to a second control signal equivalent to said first control signal; and
a projector, said projector including:
a projection processing part to project said image;
an input device to input a control signal; and
a second Ethernet interface device,
wherein said second Ethernet interface device transmits control data based on said control signal to said first Ethernet interface device and receives image data that correspond to said image from said first Ethernet interface device,
wherein said first Ethernet interface device receives said control data from said second Ethernet interface device and transmits said image data that correspond to said image to said second Ethernet interface device,
wherein said image development part is controlled based on said first control signal and on said second control signal alternatively, and
wherein said projection processing part projects said image based on said image data.

38. A computer-readable medium encoded with a computer program to be executed by a computer, said program comprising:
receiving a first control signal from an input device via a device port;
receiving control data from a projector via an Ethernet interface device;
converting said control data to a second control signal equivalent to said first control signal;
controlling an image development part based on said first control signal and on said second control signal alternatively; and
transmitting image data that correspond to an image developed by said image development part.

39. A presentation method, comprising:
receiving a first control signal from an input device via a device port;
receiving control data from a projector via an Ethernet interface device;
converting said control data to a second control signal equivalent to said first control signal;
controlling an image development part based said first control signal and on said second control signal alternatively; and
transmitting image data that correspond to an image developed by said image development part.
